(19) United States
(12) Patent Application Publication
(10) Pub. No.: US 2012/0119526 A1
(43) Pub. Date: May 17, 2012

(54) Deformation element for a motor vehicle

(75) Inventors: EDVIN LIST CLAUSEN, Lojt Kirkeby Abenra (DK); Kathy HANSEN, Tonder (DK); Thomas LØKKE, Tonder (DK)

(73) Assignee: Benteler Automobiltechnik GmbH, Paderborn (DE)

(21) Appl. No.: 13/217,863

(22) Filed: Aug. 25, 2011

(30) Foreign Application Priority Data
Aug. 26, 2010 (DE) 10 2010 035 619.0

(51) Int. Cl. B60R 19/34

(52) U.S. Cl. 293/133

(57) ABSTRACT

A deformation element for a motor vehicle for absorbing kinetic energy caused by an impact, through plastic deformation includes a base body having an outer surface area formed with depressions for stiffening. The depressions are directed into the base body and extend in a longitudinal direction of the base body. The outer surface area of the base body has a rectangular profile in a transition from a narrow side to a broadside, and adjacent depressions have varying length.

### CROSS-REFERENCES TO RELATED APPLICATIONS

This application claims the priority of German Patent Application, Serial No. 10 2010 035 619.0, filed Aug. 26, 2010, pursuant to 35 U.S.C. 119(a)-(d).

### BACKGROUND OF THE INVENTION

The invention relates to a deformation element for a motor vehicle, in particular crash box.

Parts of vehicle structure designed as crumple zones are provided as passive protection of passengers. The goal is to substantially reduce forces acting on the passengers in the event of an accident. This is predominantly realized by a combination of elements having different stiffnesses. Individual components are hereby designed as deformation element which provides a targeted absorption of kinetic energy resultant from an impact, by being plastically deformed.

Deformation elements may, for example, be designed as crash boxes which in combination with a bumper crossbeam absorb collision forces in the event of an impact at low speed, without damage to the remainder of the body structure.

Integration into the remaining vehicle structure is hereby selected in such a way as to allow generally simple and cost-efficient replacement of the deformation elements.

In this context, deformation elements of angular cross section are known to have notches in their edge zone. The notches effect an intended weakening of the structure to force a targeted buckling and behavior that impacts the deformation pattern in the event of a longitudinally directed impact. As a result, the deformation element is compressed in a controlled manner, with the individual outer surface areas between two adjacent notches folding and crumpling in order to convert as much impact energy into deformation energy as possible.

Crash boxes are also known which have in relation to their longitudinal installation position in travel direction of the motor vehicle depressions extending in transverse direction thereto to effect a targeted crumpling of the outer surface area in the event of a crash.

DE 10 2004 039 592 B4 discloses a crash box for installation between a side rail and a bumper crossbeam of a motor vehicle. Its deformation member is provided to absorb kinetic energy caused by a crash through plastic deformation. The crash box includes a base body in the shape of a pyramid which has depressions in some regions of its outer surface area for stiffening. The depressions extending transversely to the longitudinal direction of the crash box are each directed laterally inwards and outwards, with the depression pattern being variable and possibly including also depressions extending in longitudinal direction of the crash box.

Crash boxes may not be too soft however as they support the bumper. Therefore, the wall thickness required for the stiffness must be precisely suited to the afore-described notches or the arrangement of depressions extending in transverse direction.

The current configuration of deformation elements has thus still room for improvements with respect to weight reduction with the goal to lower fuel consumption.

### SUMMARY OF THE INVENTION

The present invention is based on the object to improve a deformation element for a motor vehicle in such a way that in addition to its task of absorbing impact energy through deformation and having low weight at the same time, a simple mode of production is possible.

The object is solved in accordance with the invention by a deformation element for a motor vehicle, in particular a crash box, for absorbing kinetic energy, caused by an impact, through plastic deformation, including a base body which has in sections of its outer surface area depressions for stiffening, wherein the depressions are directed into the base body and all extend in the longitudinal direction thereof, wherein the outer surface area of the base body has a rectangular profile in the transition from its narrow sides to its broadsides, and adjacent depressions have varying.

Accordingly, the deformation element includes a base body which has an outer surface area provided with depressions in at least some regions thereof for stiffening. The deformation element is provided to absorb kinetic energy caused by an impact, through axial plastic deformation.

In accordance with the invention, the depressions are directed into the base body in relation to the surrounding outer surface area. In this way, the sometimes limited and tight installation space is not influenced by projecting portions of the depressions. Already existing components that have been conformed to the existing installation space can now also be exchanged and replaced subsequently by lighter deformation elements which are provided with a depression. Furthermore, the depressions extend all in longitudinal direction of the base body.

The outer surface area of the base body has a rectangular profile at each transition from their narrow sides to the broadsides. Furthermore, adjacent depressions have different lengths.

The depression provided in the outer surface area changes the cross sectional profile of the base body so that webs extending in particular between the depression base and the surrounding outer surface area result in an increase of the section modulus of the deformation element.

The particular advantage resides in the possibility of a resultant weight saving. This is attained by the increased stiffness of the base body as a result of the depression which stiffness is again adjusted to the required value through reduction of the wall thickness. Tests have shown weight savings of up to 30%. In combination with further secondary shapes that change the cross section of the base body, for example notches in the edge region, the deformation behavior can be controlled in a targeted manner while reducing the weight of the component at the same time.

In relation to the longitudinal direction of the motor vehicle, the base body is arranged parallel or at an angle in the plane of the transverse direction of the motor vehicle. The angle between the vehicle longitudinal direction and longitudinal direction of the base body ranges hereby from 0° to 30°. The depressions themselves may also extend at an angle from 0° to 30° relative to the longitudinal direction of the base body or oriented parallel thereto. In principle, several depressions can be arranged in the outer surface area of the deformation element and extend substantially in parallel relationship.

Depending on the number, depth as well as width and shape of the depression, the thus changing section modulus of the deformation element can be adjusted to the need at hand. In principle, the outer surface area may hereby also have regions of different wall thicknesses in order to establish in combination with the depression the desired properties with respect to weight of the structure and deformation behavior.

Advantageous refinements of the basic inventive idea are the subject matter of the dependent claims.

The depression is provided by stamping the outer surface area of the base body. The provision of the depression in the outer surface area may be realized in several ways. The base body itself may be formed for example from a roll-formed semifinished product in which the depression is introduced already before or during its formation. The base body is hereby produced through forming an initially flat semifinished product through repeated bending. The connection of the ends of the roll-formed semifinished product, which normally extend in longitudinal direction, may be implemented for example by welding or in general by a material joint. Welding may be realized for example by butt welding along the abutting edges.

In principle, the base body may also be formed from an extrusion profile in which the depression is formed subsequently. The depression may also be formed directly into the extrusion profile by the extrusion tool. The possibility to form the base body for example from two nested and subsequently at least spot-welded C-sections is also conceivable within the scope of the invention.

In accordance with the respective requirements, the depression has a profile which varies in longitudinal direction of the base body. The profile of the depression may for example be continuous or arranged only in a limited length portion. Depending on the requirement, the depression may have a straight or angled as well as alternating profile. Varying depths of the depression base are also conceivable. Also the respective width of the depression may have sections that are adjusted. In principle, individual openings may be introduced in sections of the depression. By conforming the depression provided by stamping, the desired section modulus and the required crumpling forces of the deformation element are adjusted and its profile suited depending on the configuration.

According to a refinement of the invention, the base body has one or more chambers extending in its longitudinal direction. The individual chambers are separated from one another by an intermediate web which affects an increase of the section modulus of the deformation element. Depending on the configuration, the intermediate web may be formed already during formation of the semifinished product by providing a projection directed into the base body. In principle, the intermediate web may also be rolled into the base body produced through forming. The intermediate web may hereby be connected with the base body within the base body by clamps or for example by welding. The base body as well as also individual chambers may be foamed with suitable material at least in sections thereof. The individual chambers of the base body may also be formed by juxtaposing several rectangular profiles for example. The connection of the individual rectangular profiles may for example be realized by welding or bonding.

The depression formed in the outer surface area of the base body is distanced from the respective ends of the base body. As a result, the depression does not extend to the border regions of the base body so that its stiffening effect is established between the ends of the base body. In order to attain a linear transition of the stiffnesses of the deformation element, the depression base of the depression can ascend continuously to the respective ends of the base body to the outer level of the outer surface area of the base body. In principle, start and end of the depressions may have a sudden pattern between depression base and surrounding outer surface area, with the depression ascending in one or more steps to the plane of the outer surface area.

A variation of the depression provides for the depression in the outer surface area of the base body to start and end at the border side at least on one of its ends. This configuration is to be chosen when the structure to be connected with the deformation element has a respective configuration in order to be able to receive the cross section of the base body which changes with the depressions at the border side. The structure to be connected with the deformation element engages hereby into or about an end portion of the base body.

Advantageously, the formation of a depression by an extrusion tool in an extrusion profile is also limited to individual portions. By then cutting the extrusion profile to size to form individual base bodies, the latter have only some sections provided with a depression. Preferably, the extrusion profile is to be cut to size in such a way that the base body has a depression which starts from the border of one end and extends to the opposite end of the base body and which is distanced from this end. In principle, the thus produced depression may also be distanced from both ends of the base body.

Provision is made for the outer surface area of the base body to have at least one opening. The opening is arranged in the region of the ends of the base body. The openings can be realized by drilling for example. Advantageously, the openings are punched into the outer surface area of the base body. Preferably, the openings are formed together with the depression in the outer surface area of the base body. The deformation element can be connected with surrounding structures of the motor vehicle via the openings.

The connection provides that the ends of the deformation element engage in a surrounding structure or engage around the latter. The surrounding structure has also in the paired state an opening in coincidence with the opening of the deformation element. A connection may for example be established by a bolt via the openings. Advantageously, the connection element is detachably configured to enable a rapid exchange of the deformation element.

In principle, the deformation element may also be connected by various other types of connection with surrounding structures of the motor vehicle. The connection of the deformation element to surrounding structures may be established for example by welding, soldering, clamping, or bonding as well as combinations thereof.

Even when the deformation element is made for example from plastic or fiber-reinforced materials, the base body is preferably made of metal. As a result, the deformation element fits into the base structure of the motor vehicle that is normally manufactured of metal. In order to realize a highest possible weight saving potential, the deformation element is preferably formed from a base body of aluminum.

The base body of the deformation element is preferably formed from a continuous hollow section because this provides the greatest weight saving.

The afore-described invention provides a deformation element for a motor vehicle, in particular a crash box, which besides its task to absorb impact energy through deformation has especially reduced weight. Formation of the depression directed in longitudinal direction of the base body increases the section modulus of the deformation element so that the wall thickness can be reduced. The depression is hereby provided in the base body of the deformation element in such a way that the plastic deformation starts from the side of force introduction in the event of a crash. Thus, the base body begins to crumple from the area of the force introduction whereas the remaining base body maintains a stable shape. Depending on the impact speed, crumpling continuous from the region of the load introduction through the base body through further crumpling. In this way, as much energy as possible is absorbed through plastic deformation.

The deformation element is configured such that a controlled interaction between local weakenings of the base body and the depression is realized. The depression may hereby stiffen weakened regions of the base body, for example through stamping, in a targeted manner so that this region undergoes a controlled buckling of the base body only when a certain load variable is exceeded. This prevents premature and/or uncontrolled crumpling of the deformation element.

The depression is configured in accordance with a predefined force distance curve. In particular at axial compression, the deformation element is adjusted by the provided depression such that the smallest necessary crumpling forces are arranged in the region of the force application. From there, the necessary crumpling forces for deformation of the base body increase linearly and/or exponentially. In particular, in light of the ecological background and the aim to further lower the vehicle weight for fuel saving, the invention provides a respective weight saving potential, whereby the demanded safety standards are met, despite diminished material use.

### BRIEF DESCRIPTION OF THE DRAWING

FIG. 1 shows a perspective view of a first embodiment of a deformation element according to the present invention; and

FIG. 2 shows a perspective view of a second embodiment of a deformation element according to the present invention.

The invention will now be described in greater detail with reference to the drawings which schematically illustrate an exemplary embodiment.

### DETAILED DESCRIPTION OF PREFERRED EMBODIMENTS

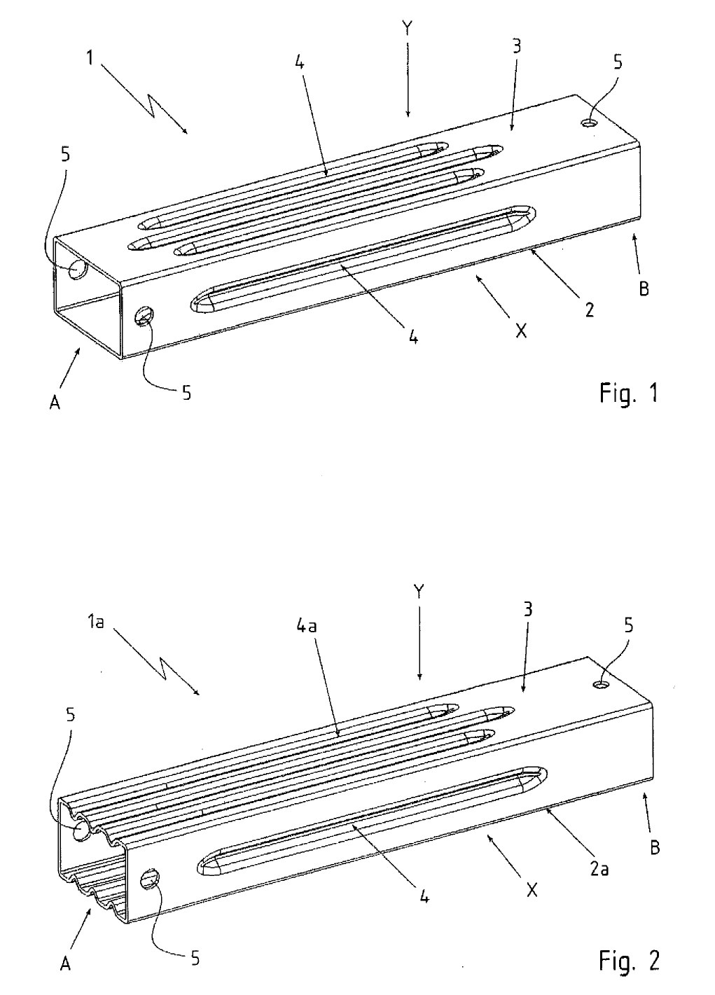

FIG. 1 shows a deformation element 1 according to the invention which is formed from a base body 2 of rectangular cross section. The base body 2 extends as hollow section in longitudinal direction between its ends A, B. The base body 2 has on its outer surface area 3 individual depressions 4 which are distanced to the respective ends A, B of the base body 2. The depressions 4 are hereby directed into the base body 2 and all extend in the longitudinal direction thereof. The rectangular cross section of the base body 2 has only one depression 4 on one of its narrow sides X whereas the broadsides Y thereof have three depressions 4 in parallel relationship. The center depression 4 positioned on the broadside Y of the base body 2 is hereby configured longer than its adjacent depressions 4. The ends A, B of the base body 2 in the form of the hollow section are open.

Arranged in the area of each of the ends A, B of the base body 2 are individual openings 5, respectively, which penetrate through the outer surface area 3 of the deformation element 1. The openings 5 at the end A of the base body 2 oppose one another on the narrow side X of the base body 2 whereas the opening 5 at the end B of the base body 2 is provided in the broadside Y of the base body 2. The outer surface area 3 of the base body 2 has a rectangular profile in each transition from its narrow sides X to the broadsides Y.

FIG. 2 shows a variant of the deformation element 1 of FIG. 1. A deformation element 1a shown here has, compared to the afore-described deformation element 1, a different characteristic of the depressions 4. The individual depressions 4a extend here on the broadside Y of the outer surface area 3 to the end A of a base body 2a. As a result, the end A of the base body 2a has at the border side a corrugated profile which is determined by the depth and shape of the depressions 4a formed in the outer surface area 3 and directed into the base body 2a.

1.-9. (canceled)

10. A deformation element for a motor vehicle, for absorbing kinetic energy, caused by an impact, through plastic deformation, said deformation element comprising a base body having an outer surface area formed with depressions for stiffening, said depressions being directed into the base body and extending in a longitudinal direction of the base body, wherein the outer surface area of the base body has a rectangular profile in a transition from a narrow side to a broadside, and wherein adjacent depressions have varying length.

11. The deformation element of claim 10, constructed in the form of a crash box.

12. The deformation element of claim 10, wherein each depression is provided by stamping the outer surface area of the base body.

13. The deformation element of claim 10, wherein each depression has a profile of varying configuration in the longitudinal direction of the base body.

14. The deformation element of claim 10, wherein the base body has one or more chambers extending in the longitudinal direction of the base body.

15. The deformation element of claim 10, wherein each depression is distanced from opposite ends of the base body.

16. The deformation element of claim 10, wherein each depression in the outer surface area of the base body begins or ends at a border side at least on one end of the base body.

17. The deformation element of claim 10, wherein the outer surface area has at least one opening which is arranged in a region of opposite ends of the base body.

18. The deformation element of claim 10, wherein the base body is made of metal.

19. The deformation element of claim 10, wherein the base body is formed from a hollow section.
